(19) United States
(12) Patent Application Publication
(10) Pub. No.: US 2007/0257219 A1
(43) Pub. Date: Nov. 8, 2007

(54) Double diaphragm actuator

(75) Inventor: Jean-Luc Perrin, Girmont (FR)

Correspondence Address: HONEYWELL TURBO TECHNOLOGIES, 23326 HAWTHORNE BOULEVARD, SUITE #200, TORRANCE, CA, 90505, US

(73) Assignee: Honeywell International, Inc.

(21) Appl. No.: 11/416,286

(22) Filed: May 2, 2006

(51) Int. Cl. F16K 31/00

(52) U.S. Cl. 251/61.5

(57) ABSTRACT

The present invention relates to a control device actuator, particularly a turbocharger control actuator, comprising at least two diaphragms to increase the surface area of the actuator that is responsive to a pressure differential thus increasing the amount of force that can be applied to a control device through the actuator.

### CROSS-REFERENCES TO RELATED APPLICATIONS

Not Applicable.

### BACKGROUND OF THE INVENTION

1. Field of the Invention (Technical Field)

The present invention relates to diaphragm actuators that are responsive to pressure, particularly for use with turbocharger control devices. More particularly, the present invention relates to an actuator having more than one diaphragm.

2. Description of Related Art

Note that where the following discussion refers to a number of publications by author(s) and year of publication, because of recent publication dates certain publications are not to be considered as prior art vis-a-vis the present invention. Discussion of such publications herein is given for more complete background and is not to be construed as an admission that such publications are prior art for patentability determination purposes.

Pressure-responsive actuators used where fast, simple devices are needed for linear or cable actuation. Examples of such use include the control of valves in turbocharger applications such as waste gate valves, blow-off valves, turbine bypass mechanisms, and compressor inlet control valves.

In a typical configuration of an actuator of the prior art wherein a valve or valve assembly is acted upon, the actuator includes a housing that surrounds a pressure driven piston and depending rod. A resilient diaphragm divides the housing into a pair of separate chambers. At least one inlet port is coupled to a chamber and to a source of pressure or vacuum to subject the diaphragm to a prescribed pressure differential. Thus, changes in the pressure differential, such as that which occurs during increases or decreases in engine speed or load, cause displacement of the diaphragm and piston which in turn displaces the actuator rod. The rod projects out of the housing and is connected to the valve assembly for positioning the valve, thus controlling turbocharger operations.

In some applications, the high gas pressure in the system which is controlled by a valve or valve assembly to which the actuator is applied may be so high as to make it difficult for the actuator to generate enough force to counteract the pressure and close the valve and/or ensure sealing. For example, in dual stage, or two-stage, turbocharger systems, the turbine valve that regulates the second turbocharger works under such high gas pressure and is thus designed with a large surface section to allow good gas flow. Consequently, the actuator must generate a relatively large amount of force. Typically, such needed force is accomplished through the use of an actuator having a large diameter. However, this larger size is more difficult to accommodate.

There is therefore a need for a diaphragm actuator that can respond quickly to pressure differentials, can be easily accommodated in to the design of the system to which it is applied, such as a two-stage turbocharger system, and can generate a relatively high amount of force.

### BRIEF SUMMARY OF THE INVENTION

The present invention provides an actuator having more than one diaphragm. Thus, an embodiment of the present invention provides an actuator comprising at least two canister bodies secured to each other, each canister body comprising a cylindrical body joined to a cover cap to form an interior cavity, a diaphragm dividing the cavity into two chambers, at least one of the chambers connected to a pressure source capable of generating a pressure differential in the chambers and said diaphragm responsive to the pressure differential in said chambers, and a piston disposed in the cavity between the chambers, said piston movable in response to the pressure differential in the chambers, and an actuator rod connected from a first portion to the pistons and connectable from a second portion to a control device.

The actuator preferably further comprises a spring disposed within at least one of the canister bodies for exerting a biasing force on the pistons and the diaphragms.

In an embodiment, the control device acted upon by the actuator is a turbocharger control valve. In another embodiment, the control device is a control valve for a second turbocharger of a two-stage turbocharger assembly.

In one embodiment, the pressure source generates and introduces a positive pressure into at least one of the chambers. Alternatively, the pressure source generates and introduces a vacuum into at least one of said chambers. In still another embodiment, a combination of pressure sources, positive pressure or vacuum, may be used between canisters or within each canister, or both.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into, and form a part of, the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side, cross section view of an embodiment of the present invention; and

FIG. 2 is a side, cross section view of another embodiment of the present invention.

### DETAILED DESCRIPTION OF THE INVENTION

The present invention provides an actuator having more than one diaphragm to provide for an increase in surface area of the actuator being acted upon by a pressure differential, while leaving an external diameter of the actuator substantially the same as what would otherwise be utilized in a single diaphragm actuator. Thus, the present invention provides for an actuator capable of generating more force relative to its external diameter than single diaphragm actuators of the prior art. As used in the specification and claims herein, the terms “a”, “an”, and “the” mean one or more.

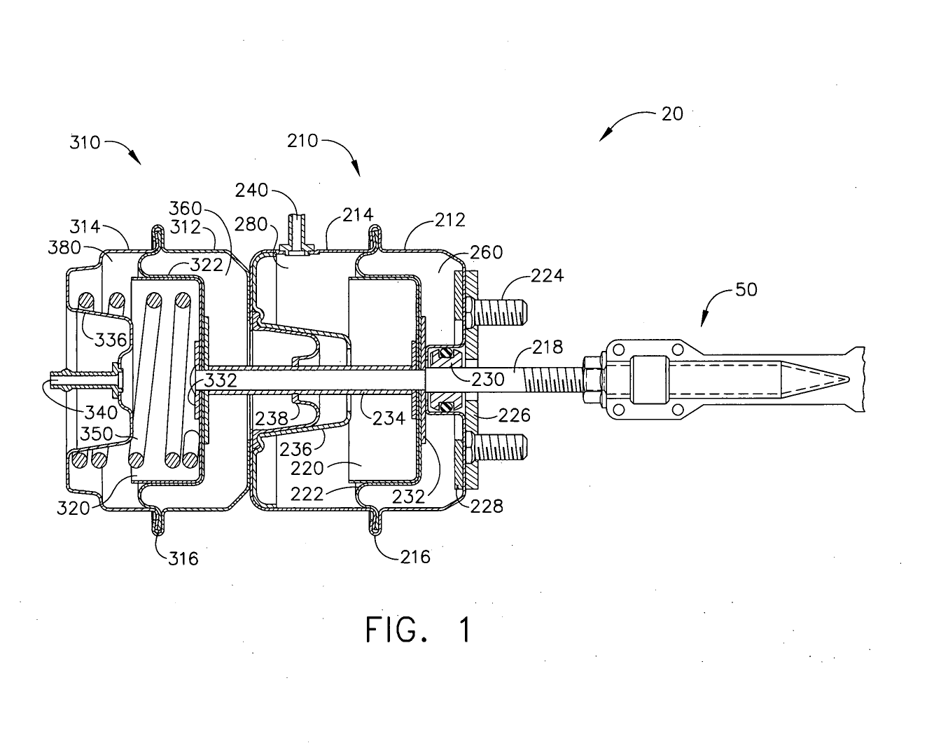

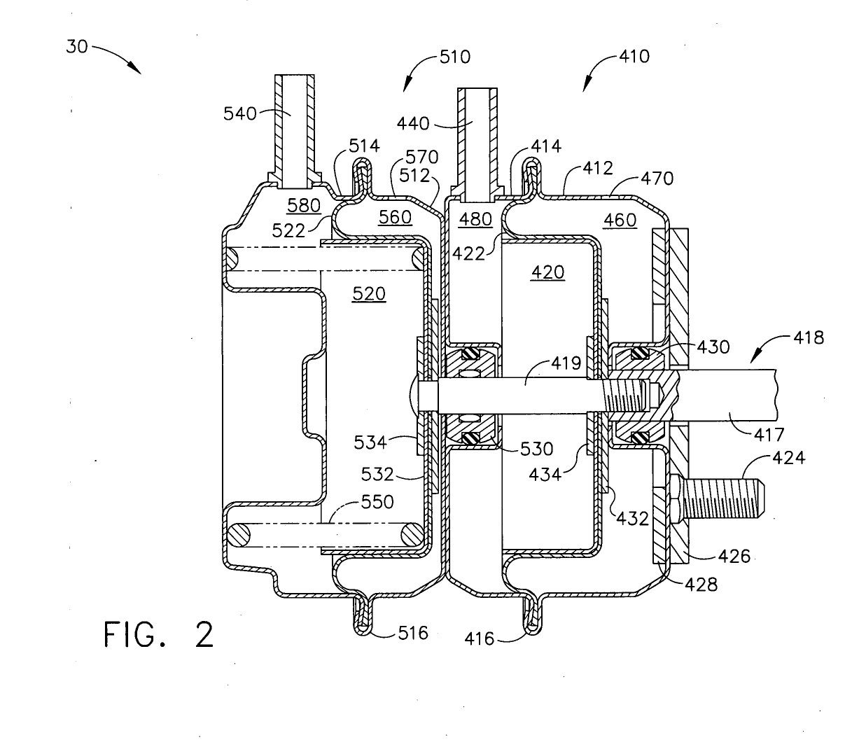

In the preferred embodiments, the actuator comprises two diaphragms as shown in the non-limiting embodiments of FIGS. 1 and 2. Also, the embodiments shown in the figures, and which are illustrative of the various embodiments within the scope of the present invention, show a piston/rod assembly that is responsive to a source of vacuum. However, other sources for the pressure differential may be utilized as known in the art, including pneumatic sources.

FIG. 1 shows actuator 20 comprising canister 210 and canister 310 joined to each other through any means known in the art such as, but not limited to, welds, with a portion of actuator rod 218 disposed within canister 210 and another portion disposed within canister 310. Actuator rod comprises valve linkage assembly 50 disposed at one end for connecting to a valve or valve assembly (not shown).

Canister 210 comprises cylindrical body 212 and cover cap 214 which are joined to each other at joint 216 to form a cavity. Cylindrical body 212 is secured to a mounting surface (not shown) using studs 224 attached to mounting plate 226. A portion of cylindrical body 212 is sandwiched between mounting plate 226 and plate 228.

Joint 216 is a crimped joint formed by a lip portion of cover cap 214 crimped between a bottom and a top of a lip of cylindrical body 212. A lip portion of diaphragm 222 fits between the lip portion of cover cap 214 and the lip of cylindrical body 212. Connected to rod 218 and disposed within canister 210 is piston 220 secured to rod 218 via piston cap plate 232 and rod casing 234. Rod casing 234 surrounds a section of rod 218 that is disposed between piston 220 and second piston 320, the latter of which is disposed in canister 310. A portion of diaphragm 222 is sandwiched between piston cap plate 232 and piston 220. Thus, diaphragm 222 separates the cavity within canister 210 into two chambers, chamber 260 and chamber 280. Chamber 280 is connected to a source of differential pressure, such as a vacuum source, via port fitting 240. Therefore, as vacuum is applied, piston 220 and rod 218 move axially away from the mounting surface while canister 210 remains stationary. Seal 230 and flexible seal 238 provide a seal against any leakage about rod 218. Seal 238 is disposed within retainer cup 236 and is held by retainer cup 236 against the inner wall of cover cap 214.

When vacuum pressure is returned to the initial state, spring 350 within canister 31 0 biases piston 220 back toward the mounting surface of actuator 20. Similar to the configuration of canister 210, canister 310 comprises piston 320 disposed within canister 310 and connected to rod 218 via inner piston plate 332. Piston 320 is moveable in concert with piston 220 as vacuum is applied through port fitting 340 into chamber 380. As with canister 210, chamber 380 is separated from chamber 360 via diaphragm 322. Diaphragm 322 is sandwiched between rod casing 234 and piston 320. Diaphragm 322 is also secured at joint 316 which joins cylindrical body 312 to cover cap 314 in the same manner as described above with respect to joint 216. Spring 350 is held in place by inner protrusion 336 of cover cap 314.

FIG. 2 shows another embodiment comprising the same principles described with regard to FIG. 1. In the embodiment shown in FIG. 2, actuator 30 comprises canister 410 and canister 510 which are securely joined to each other. Canister 410 is secured to amounting surface (not shown) via at least one stud 424, mounting plate 426, and plate 428. Canister 410 comprises cylindrical body 412 joined to cover cap 414 via crimp joint 416. Actuator rod 418 comprises section 417 and section 419, the latter having a smaller diameter than the former. Piston 420 is secured to rod 418 via piston cap plate 432 and inner plate 434. A portion of diaphragm 422 is sandwiched between cap plate 432 and piston 420 and is also joined to canister 410 via crimp joint 416. Thus, diaphragm 422 separates the cavity within canister 410 into chamber 460 and chamber 480. Chamber 480 is in communication with a source of pressure differential vial port fitting 440. Seals 430 and 530 guard against leakage about rod 418.

In much the same manner as canister 410, canister 510 comprises cylindrical body 512 joined to cover cap 514 via crimp joint 516. Piston 520 is secured to section 419 of rod 418 via piston cap plate 532 and inner plate 534. A portion of diaphragm 522 is sandwiched between cap plate 532 and piston 520 and is also joined to canister 510 via crimp joint 516. Thus, diaphragm 522 separates canister 510 into chamber 560 and chamber 580. Chamber 580 is in communication with a source of pressure differential vial port fitting 540. As in the embodiment shown in FIG. 1, spring 550 within canister 510 biases the pistons toward the actuator's mounting surface when vacuum is not applied (in this embodiment, spring 510 is oriented in a direction perpendicular to the orientation of spring 350 in FIG. 1). Ports 470 and 570 expose chambers 460 and 560, respectively, to atmospheric pressure.

It is readily understood from the descriptions regarding FIGS. 1 and 2 that any orientation and means used to connect and join the various components may be utilized as long as two or more diaphragms are utilized that are responsive to pressure differentials, whether vacuum and/or pressure, and that can separate the body of at least two canisters in to at least two chambers. Thus, a pressure, vacuum, or a combination of pressure and vacuum chambers can be utilized in the practice of the present invention. For example, within one canister, one chamber can receive positive pressure and another chamber can receive the application of vacuum. In another example, a piston of one canister can be moved in response to positive pressure while the other piston moves in response to vacuum. Any combination is possible within the scope of the present invention which is directed to the increase of surface area (e.g., diaphragm surface area) within an actuator that is responsive to pressure differentials while maintaining the outer diameter of the actuator found in a single diaphragm actuator, thus increasing the force that can be applied via the former to a valve or other control device.

The preceding examples can be repeated with similar success by substituting the generically or specifically described components, mechanisms, materials, and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A turbocharger control actuator comprising:
at least two canister bodies secured to each other, each said canister body comprising:
a cylindrical body joined to a cover cap to form an interior cavity;
a diaphragm dividing said cavity into two chambers, at least one of said chambers connected to a pressure source capable of generating a pressure differential in said chambers and said diaphragm responsive to said pressure differential in said chambers; and
a piston disposed in said cavity between said chambers, said piston movable in response to said pressure differential in said chambers; and
an actuator rod connected from a first portion to said pistons and connectable from a second portion to a control device.

2. The turbocharger control actuator of claim 1 further comprising a spring disposed within at least one of said canister bodies for exerting a biasing force on said pistons and said diaphragms.

3. The turbocharger control actuator of claim 1 wherein said control device is a turbocharger control valve.

4. The turbocharger control actuator of claim 1 wherein said control device is a control valve for a second turbocharger of a two-stage turbocharger assembly.

5. The turbocharger control actuator of claim 1 wherein said pressure source generates and introduces a positive pressure into at least one of said chambers.

6. The turbocharger control actuator of claim 1 wherein said pressure source generates and introduces a vacuum into at least one of said chambers.

7. An actuator comprising:
at least two canister bodies secured to each other, each said canister body comprising:
a cylindrical body joined to a cover cap to form an interior cavity;
a diaphragm dividing said cavity into two chambers, at least one of said chambers connected to a pressure source capable of generating a pressure differential in said chambers and said diaphragm responsive to said pressure differential in said chambers; and
a piston disposed in said cavity between said chambers, said piston movable in response to said pressure differential in said chambers; and
an actuator rod connected from a first portion to said pistons and connectable from a second portion to a control device.

8. The actuator of claim 7 further comprising a spring disposed within at least one of said canister bodies for exerting a biasing force on said pistons and said diaphragms.

9. The actuator of claim 7 wherein said control device is a turbocharger control valve.

10. The actuator of claim 7 wherein said pressure source generates and introduces a positive pressure into at least one of said chambers.

11. The actuator of claim 7 wherein said pressure source generates and introduces a vacuum into at least one of said chambers.
